(19) United States
(12) Patent Application Publication
(10) Pub. No.: US 2022/0225591 A1
(43) Pub. Date: Jul. 21, 2022

(54) EXCREMENT TREATMENT MATERIAL AND METHOD FOR MANUFACTURING THE SAME

(71) Applicant: DAIKI CO., LTD., Tokyo (JP)

(72) Inventor: Junji YOSHINAGA, Tokyo (JP)

(73) Assignee: DAIKI CO., LTD., Tokyo (JP)

(21) Appl. No.: 17/713,368

(22) Filed: Apr. 5, 2022

Related U.S. Application Data
(63) Continuation-in-part of application No. PCT/JP2020/039823, filed on Oct. 23, 2020.

(30) Foreign Application Priority Data
Dec. 19, 2019 (JP) 2019-228797

(51) Int. Cl. A01K 1/015; A01K 1/01

(52) U.S. Cl. CPC A01K 1/0155; A01K 1/0107

(57) ABSTRACT

An excrement treatment material is composed of a plurality of grains that are piled in a box-shaped toilet and have a water absorbing property. The plurality of grains include a first grain and a second grain. The first grain and the second grain absorb urine excreted in the toilet. The water absorption rate of the second grain is smaller than the water absorption rate of the first grain.

### CROSS REFERENCE TO RELATED APPLICATION

This is a Continuation-in-part of International Application No. PCT/JP2020/039823 filed Oct. 23, 2020, which claims the benefit of Japanese Application No. 2019-228797 filed Dec. 19, 2019. The contents of these applications are hereby incorporated by reference in their entirety.

### TECHNICAL FIELD

The present invention relates to an excrement treatment material and a method for manufacturing the same.

### BACKGROUND ART

A conventional excrement treatment material is disclosed in, for example, Patent Document 1. The excrement treatment material disclosed in Patent Document 1 is an excrement treatment material for animals, and composed of a plurality of grains. Each of the grains is a water absorbing grain that absorbs urine. As shown in FIG. 4, an excrement treatment material 90 configured in this way is used in a state in which a plurality of grains 92 are piled in a box-shaped toilet 94.

### CITATION LIST

### Patent Document

Patent Document 1: JP 2007-190026 A

### SUMMARY OF INVENTION

### Technical Problem

In the toilet 94, urine 96 is excreted from above the excrement treatment material 90. Therefore, the urine 96 is absorbed mainly by the grains 92 located in the uppermost layer of the excrement treatment material 90 (the black-painted grains 92 in FIG. 4). For that reason, it follows that most of the excreted urine 96 stays in the vicinity of the upper surface of the excrement treatment material 90. If the urine 96 stays in the vicinity of the upper surface of the excrement treatment material 90 in this way, an odor generated from the urine 96 becomes likely to be released outside the toilet 94.

### Solution to Problem

The present invention has been made in view of the above-described problem, and it is an object thereof to provide an excrement treatment material that can restrain release of an odor generated from excreted urine, and a method for manufacturing the same.

An excrement treatment material according to the present invention is composed of a plurality of grains that are piled in a box-shaped toilet and have a water absorbing property. The plurality of grains include a first grain that absorbs urine excreted in the toilet, and a second grain that absorbs the urine. A water absorption rate of the second grain is smaller than a water absorption rate of the first grain.

This excrement treatment material is provided with the first and second grains. The water absorption rate of the second grain is smaller than the water absorption rate of the first grain. Reducing the water absorption rate of the second grain in this way makes it easier for excreted urine to be guided downward in the toilet. For this reason, urine can be dispersed widely in the depth direction of the toilet, compared to a case where only the first grain is provided. Dispersing urine in the depth direction in this way leads to reducing the ratio of urine that stays in the vicinity of the upper surface of the excrement treatment material. Thus, an odor generated from the urine can be restrained from being released outside the toilet.

A method for manufacturing an excrement treatment material according to the present invention is a method for manufacturing an excrement treatment material composed of a plurality of grains that are piled in a box-shaped toilet and have a water absorbing property. The method includes: a first grain forming step of forming a first grain that absorbs urine excreted in the toilet; and a second grain forming step of forming a second grain that absorbs the urine. In the second grain forming step, the second grain is formed such that a water absorption rate of the second grain is smaller than a water absorption rate of the first grain.

In this manufacturing method, the first and second grains are formed. The water absorption rate of the second grain is smaller than the water absorption rate of the first grain. Reducing the water absorption rate of the second grain in this way makes it easier for excreted urine to be guided downward in the toilet in the manufactured excrement treatment material. For this reason, urine can be dispersed widely in the depth direction of the toilet, compared to a case where only the first grain is formed. Dispersing urine in the depth direction in this way leads to reducing the ratio of urine that stays in the vicinity of the upper surface of the excrement treatment material. Thus, an odor generated from the urine can be restrained from being released outside the toilet.

### Advantageous Effects of Invention

According to the present invention, it is possible to implement an excrement treatment material that can restrain release of an odor generated from excreted urine, and a method for manufacturing the same.

### BRIEF DESCRIPTION OF DRAWINGS

FIG. 1 is a schematic view showing an embodiment of an excrement treatment material according to the present invention.

FIG. 2 is a schematic view showing a grain 10.

FIG. 3 is a schematic view showing a grain 20.

FIG. 4 is a diagram for illustrating a problem of the conventional excrement treatment material.

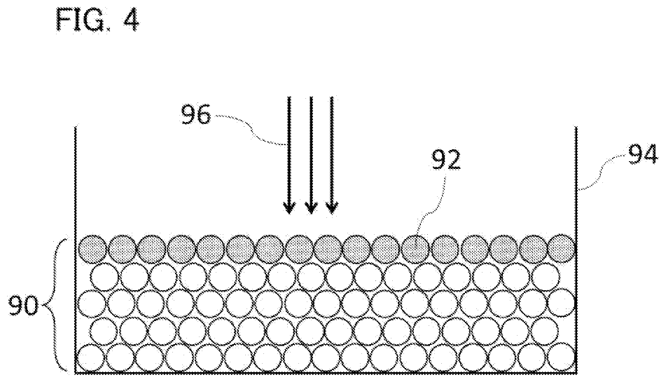

### DESCRIPTION OF EMBODIMENTS

Hereinafter, an embodiment of the present invention will be described in detail with reference to the drawings. In the description of the drawings, the same elements are given the same reference numerals, and a redundant description will be omitted.

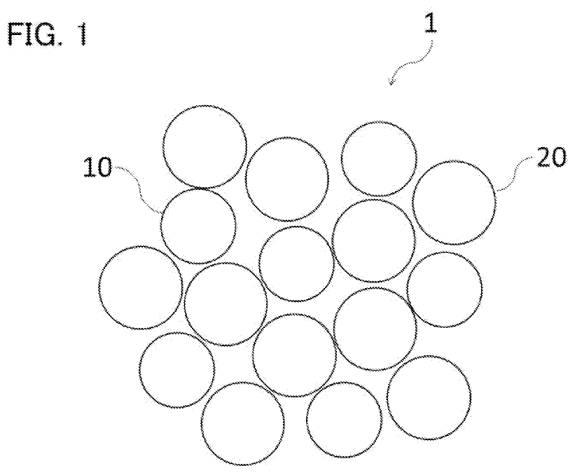

FIG. 1 is a schematic view showing an embodiment of an excrement treatment material according to the present invention. An excrement treatment material 1 is an excrement treatment material used for treatment of excrement (particularly urine) of humans or animals, and composed of a plurality of grains that are piled in a box-shaped toilet and have a water absorbing property. The excrement treatment material 1 includes a grain 10 (first grain) and a grain 20 (second grain). That is, the plurality of grains constituting the excrement treatment material 1 include the grain 10 and the grain 20.

The grain 10 and the grain 20 have a water absorbing property, and absorb urine excreted in the toilet. The grain 10 having the water absorbing property requires the water absorption rate of 40% or more measured by the following test. First, approximate 50 grams of a plurality of the grains 10 (sample) are placed in a strainer. An empty beaker is set under the strainer. Then, 30 ml of water is dripped on the sample over 10 seconds using a syringe without a needle. After waiting 1 minute, the quantity of the water in the beaker is measured. The ratio of the value obtained by subtracting the measured water quantity from the quantity of the dripped water (30 ml) with respect to the quantity of the dripped water shall be the water absorption rate. That is, if the water quantity in the beaker is 18 ml or less, the water absorption rate is 40% or more, and therefore the grain 10 is found to have the water absorbing property. The same shall apply to the grain 20.

The water absorption rate of the grain 20 is smaller than the water absorption rate of the grain 10. When the water absorption rate of the grain 10 is A % and the water absorption rate of the grain 20 is B %, (A−B)≥10 is preferably satisfied, and (A−B)≥20 is more preferably satisfied. The water absorption rate of the grain 10 is, for example, between 70% and 100% inclusive. The water absorption rate of the grain 20 is, for example, between 40% and 70% inclusive.

A plurality of the grains 10 and a plurality of the grains 20 are provided. In the excrement treatment material 1, the grains 10, 20 are provided in a mixed manner. The number of the grains 20 is preferably between 30% and 70% inclusive of the total number of the grains 10 and the grains 20, and more preferably between 40% and 60% inclusive. The particle diameter of the grain 20 is larger than the particle diameter of the grain 10. As used herein, the particle diameter is defined as the diameter of the minimum sphere that can include the grain. The particle diameter of the grain 10 is, for example, between 3 mm and 10 mm inclusive. The particle diameter of the grain 20 is, for example, between 5 mm and 15 mm inclusive.

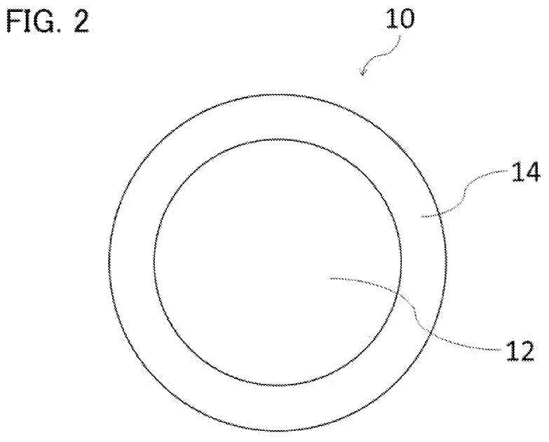

FIG. 2 is a schematic view showing the grain 10. The grain 10 takes in urine to retain it in the inside of the grain 10. The grain 10 has a core portion 12 (first granule) and a coating portion 14 (first coating portion). The core portion 12 is granulated in a granular shape. Examples of the granular shape include a sphere, column, and ellipsoid. The core portion 12 has a function of absorbing and retaining urine. The core portion 12 contains a water-absorbent material. The core portion 12 contains the water-absorbent material as its main material. As used herein, the main material of the core portion 12 refers to the material that accounts for the highest weight ratio in the core portion 12, out of one or more materials constituting the core portion 12. The core portion 12 may be composed only of the water-absorbent material, or may be composed of the water-absorbent material and another material. The water-absorbent material is preferably an organic substance. As the water absorbent material that is an organic substance, for example, papers, used tea leaves, plastics, or bean curd lees can be used. In the present embodiment, the core portion 12 does not contain an adhesive material.

The papers refer to a material composed mainly of pulp. Examples of the papers include, in addition to ordinary paper, a vinyl chloride wallpaper classified product (paper obtained by classifying vinyl chloride wallpaper), fluff pulp, papermaking sludge, and pulp sludge. As the plastics, for example, a disposable diaper classified product (plastic obtained by classifying disposable diapers) may be used. The bean curd lees are preferably dried bean curd lees.

The coating portion 14 covers the core portion 12. The coating portion 14 may cover the entire surface of the core portion 12, or may cover only a part of the surface of the core portion 12. The coating portion 14 has a function of bonding the grains 10, 20 that have absorbed urine to agglomerate them when in use. The coating portion 14 also contains a water-absorbent material as its main material. The definition of the main material of the coating portion 14 is the same as the definition of the main material of the core portion 12. The water-absorbent material contained in the coating portion 14 is also preferably an organic substance. The coating portion 14 contains an adhesive material. As the adhesive material, for example, starch, CMC (carboxymethyl cellulose), PVA (polyvinyl alcohol), dextrin, or a water-absorbent polymer can be used.

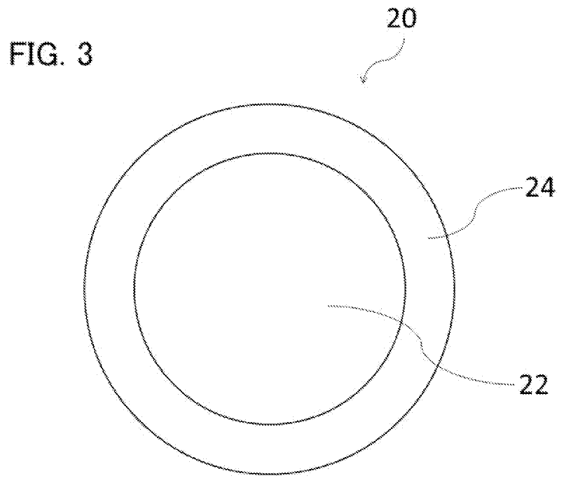

FIG. 3 is a schematic view showing the grain 20. The grain 20 takes in urine to retain it in the inside of the grain 20. The grain 20 has a core portion 22 (second granule) and a coating portion 24 (second coating portion). The core portion 22 is granulated in a granular shape. The core portion 22 has a function of absorbing and retaining urine. The core portion 22 contains a water-absorbent material. The core portion 22 contains the water-absorbent material as its main material. The definition of the main material of the core portion 22 is the same as the definition of the main material of the core portion 12. The core portion 22 may be composed only of the water-absorbent material, or may be composed of the water-absorbent material and another material. The water-absorbent material is preferably an organic substance. The core portion 22 may be made of a material that has the same composition as the core portion 12, or may be made of a material that has different composition from the core portion 12. In the present embodiment, the core portion 22 does not contain an adhesive material.

The coating portion 24 covers the core portion 22. The coating portion 24 may cover the entire surface of the core portion 22, or may cover only a part of the surface of the core portion 22. The coating portion 24 has a function of bonding the grains 10, 20 that have absorbed urine to agglomerate them when in use. The coating portion 24 also contains a water-absorbent material as its main material. The definition of the main material of the coating portion 24 is the same as the definition of the main material of the core portion 12. The water-absorbent material contained in the coating portion 24 is also preferably an organic substance. The coating portion 24 contains an adhesive material. In the present embodiment, the coating portion 24 is made of a material that has the same composition as the coating portion 14. The thickness of the coating portion 24 may be equal to or different from the thickness of the coating portion 14. In the case where the thickness of the coating portion 24 is different from the thickness of the coating portion 14, the thickness of the coating portion 24 may be larger or smaller than the thickness of the coating portion 14.

Next, an example of a method for manufacturing the excrement treatment material 1 will be described as an embodiment of the method for manufacturing an excrement treatment material according to the present invention. The manufacturing method includes a first grain forming step, and a second grain forming step.

The first grain forming step is a step of forming the grain 10. This step includes a first granulating step, and a first coating step. The first granulating step is a step of forming the core portion 12 that constitutes the grain 10. In this step, the core portion 12 is formed by granulating a first core portion material (material(s) constituting the core portion 12) with a granulation apparatus. In the present embodiment, a plurality of the core portions 12 are formed. As the granulation apparatus, for example, an extrusion granulator can be used. Prior to the granulation, the first core portion material is subjected to pretreatment such as pulverization, kneading, and adding water, as needed.

The first coating step is a step of forming the coating portion 14. In this step, the coating portion 14 is formed by attaching a powdery first coating material (materials constituting the coating portion 14) to the surface of each core portion 12 with a coating apparatus or the like. The first coating material contains the adhesive material. The first coating material may be attached by, for example, sprinkling or spraying the first coating material. Thus, the plurality of grains 10 are obtained.

The second grain forming step is a step of forming the grain 20. This step includes a second granulating step, and a second coating step. The second granulating step is a step of forming the core portion 22 that constitutes the grain 20. In this step, the core portion 22 is formed by granulating a second core portion material (material(s) constituting the core portion 22) with a granulation apparatus. The second core portion material may have the same composition as the first core portion material, or may have different composition from the first core portion material. In the present embodiment, a plurality of the core portions 22 are formed. As the granulation apparatus, for example, an extrusion granulator can be used. Prior to the granulation, the second core portion material is subjected to pretreatment such as pulverization, kneading, and adding water, as needed.

The second coating step is a step of forming the coating portion 24. In this step, the coating portion 24 is formed by attaching a powdery second coating material (materials constituting the coating portion 24) to the surface of each core portion 22 with a coating apparatus or the like. The second coating material contains the adhesive material. In the present embodiment, the second coating material has the same composition as the first coating material. The second coating material may be attached by, for example, sprinkling or spraying the second coating material. Thus, the plurality of grains 20 are obtained.

In the second grain forming step, the grain 20 is formed such that the water absorption rate of the grain 20 is smaller than the water absorption rate of the grain 10. For example, the water absorption rate of the grain 20 can be made smaller than the water absorption rate of the grain 10 by using a material that has a lower water absorbing property than the first core portion material as the second core portion material. Also, the water absorption rate of the grain 20 can be made smaller than the water absorption rate of the grain 10 by making the pressure applied to the second core portion material in the granulation of the core portion 22 higher than the pressure applied to the first core portion material in the granulation of the core portion 12. That is because gaps on the surface or in the inside of a granule decrease and therefore it becomes hard for the granule to take in urine, if the pressure in granulation is made higher. The pressure in granulation can be adjusted by, for example, changing the thickness of a die of the granulation apparatus. Specifically, the larger the thickness of a die is, the higher the pressure in granulation can be made.

Note that the first and second granulating steps may be performed in arbitrary order. That is, the both steps may be performed simultaneously in parallel, or either step may be performed prior to the other step. Similarly, the first and second coating steps may be performed in arbitrary order.

After that, the grains 10 formed in the first grain forming step and the grains 20 formed in the second grain forming step are mixed. At this time, it is preferable to mix the grains 10 and the grains 20 such that the number of the grains 20 is between 30% and 70% inclusive of the total number of the grains 10 and the grains 20. Also, it is more preferable to mix the grains 10 and the grains 20 such that the number of the grains 20 is between 40% and 60% inclusive of the total number of the grains 10 and the grains 20. Accordingly, the excrement treatment material 1 that includes the grains 10 and the grains 20 in a mixed manner is obtained.

The effects of the present embodiment will be described. In the present embodiment, the grain 10 and the grain 20 are formed. The water absorption rate of the grain 20 is smaller than the water absorption rate of the grain 10. Reducing the water absorption rate of the grain 20 in this way makes it easier for excreted urine to be guided downward in the toilet due to the ratio of urine that is not absorbed by the grain 20 increasing in the excrement treatment material 1. For this reason, urine can be dispersed widely in the depth direction of the toilet, compared to the case where only the grain 10 is formed. Dispersing urine in the depth direction in this way leads to reducing the ratio of urine that stays in the vicinity of the upper surface of the excrement treatment material 1. Thus, an odor generated from the urine can be restrained from being released outside the toilet.

Moreover, the grain 10 and the grain 20 both have a water absorbing property. Using water absorbing grains for both of the grain 10 and the grain 20 in this way can enhance water absorbability of the excrement treatment material 1 as a whole, compared to a case where a non-absorptive grain is used for either one of the grain 10 or the grain 20. Thus, it is possible to make a situation less likely to occur in which urine is not absorbed by the grain 10 or the grain 20 and thereby accumulates in the toilet.

The smaller the water absorption rate of the grain 20 is, the more easily urine is guided downward in the toilet. On the other hand, the larger the water absorption rate of the grain 10 is, the higher the water absorbability of the excrement treatment material 1 as a whole can become. From this viewpoint, when the water absorption rate of the grain 10 is A % and the water absorption rate of the grain 20 is B %, (A−B)≥10 is preferably satisfied, and (A−B)≥20 is more preferably satisfied.

It is advantageous that the grains 20 account for high ratio in the entire excrement treatment material 1 for making urine easier to guide downward in the toilet. From this viewpoint, the number of the grains 20 is preferably 30% or more of the total number of the grains 10 and the grains 20, and more preferably 40% or more. On the other hand, if the ratio of the grains 20 is too high, absorption of urine by the grains 10 may be insufficient. From this viewpoint, the number of the grains 20 is preferably 70% or less of the total number of the grains 10 and the grains 20, and more preferably 60% or less.

The smaller the particle diameter of a grain is, the more easily the grain moves downward through gaps between other grains. For that reason, in a case where grains having a relatively large particle diameter and grains having a relatively small particle diameter are poured into a toilet in a state of being mixed randomly, the former grains tend to be more likely to be disposed in the upper layer. Therefore, it becomes easy to dispose a lot of the grains 20 in the vicinity of the upper surface of the excrement treatment material 1 by making the particle diameter of the grains 20 larger than the particle diameter of the grains 10. This is advantageous for reducing the ratio of urine that stays in the vicinity of the upper surface of the excrement treatment material 1.

In the case where the core portion 12 and the core portion 22 are made of materials that have the same composition, it is possible to use the same core portion material as the core portion material for forming the core portion 12 (the first core portion material) and the core portion material for forming the core portion 22 (the second core portion material). This contributes to reduction in manufacturing costs of the excrement treatment material 1.

In the case where the core portion 12 and the core portion 22 are made of materials that have different composition, it is possible to use a material having a relatively high water absorbing property as the first core portion material, and use a material having a relatively low water absorbing property as the second core portion material. Thus, the grain 10 and the grain 20 that have mutually different water absorption rates can easily be realized.

The grain 10 and the grain 20 are both provided with the coating portion (coating portions 14, 24). Thus, bonding of the coating portions between used grains 10, 20 is obtained, and therefore an agglomeration of the grains 10, 20 can be formed stably, compared to a case where only either one of the grain 10 or the grain 20 is provided with the coating portion.

The coating portion 14 and the coating portion 24 are made of materials that have the same composition. Thus, it is possible to use the same coating material as the coating material for forming the coating portion 14 (the first coating material) and the coating material for forming the coating portion 24 (the second coating material). This contributes to reduction in manufacturing costs of the excrement treatment material 1.

The core portion 12 and the core portion 22 do not contain an adhesive material. Thus, it is possible to save the amount of the adhesive material used and thereby reduce manufacturing costs of the excrement treatment material 1.

In the case where the core portion 12 and the coating portion 14 contain an organic substance as the main material, the grain 10 can be obtained that is suitable for being disposed of by incineration. Similarly, in the case where the core portion 22 and the coating portion 24 contain an organic substance as the main material, the grain 20 can be obtained that is suitable for being disposed of by incineration. When the grains 10, 20 are suitable for being disposed of by incineration in this way, used excrement treatment material 1 can be discarded as combustible trash, and therefore convenience for the users is improved.

The present invention is not limited to the above-described embodiment, and various modifications can be made. In the above-described embodiment, the first coating step and the second coating step may be performed simultaneously with the same apparatus. That is, the first and second coating steps may be performed as one step. In that step, after mixing the core portions 12 and the core portions 22, the coating portions 14, 24 can be formed by attaching a common coating material (the first and second coating materials) to the surface of each of the core portions 12, 22 with the same coating apparatus or the like. Thus, the excrement treatment material 1 can be manufactured efficiently in which the grains 10 and the grains 20 are provided in a mixed manner. This also contributes to reduction in manufacturing costs of the excrement treatment material 1.

In the above-described embodiment, an example is given in which the coating portion 24 is made of the material having the same composition as the coating portion 14. However, the coating portion 24 may be made of a material having different composition from the coating portion 14. In that case, it is possible to use a material having a relatively high water absorbing property as the first coating material, and use a material having a relatively low water absorbing property as the second coating material.

In the above-described embodiment, an example is given in which the grain 10 and the grain 20 are both provided with the coating portion. However, only either one of the grain 10 or the grain 20 may be provided with the coating portion. For example, the grain 20 may not be provided with the coating portion 24 while the grain 10 is provided with the coating portion 14. In that case, the grain 20 has single-layer structure composed only of the core portion 22. That is, the core portion 22 is uncovered in the grain 20. Providing only a part of grains (the grain 10) with the coating portion makes it possible to save the coating material. Moreover, the bonding effect of the coating portion 14 provided in the grain 10 is also exerted on the grain 20 around the grain 10. For this reason, even though the grain 20 is not provided with a coating portion, an agglomeration composed of used grains 10, 20 is formed. Accordingly, it is possible to obtain an agglomeration of the grains 10, 20 after use while saving the coating material.

Note that neither the grain 10 nor the grain 20 may be provided with a coating portion. That is, the grain 10 and the grain 20 both may have single-layer structure composed only of the core portion (core portions 12, 22).

In the above-described embodiment, an example is given in which the core portion 12 does not contain an adhesive material. However, the core portion 12 may contain an adhesive material. The same shall apply to the core portion 22.

In the above-described embodiment, an example is given in which the particle diameter of the grain 20 is larger than the particle diameter of the grain 10. However, the particle diameter of the grain 20 may be equal to or smaller than the particle diameter of the grain 10.

### LIST OF REFERENCE NUMERALS

1 Excrement Treatment Material

10 Grain (First Grain)

12 Core Portion (First Granule)

14 Coating Portion (First Coating Portion)

20 Grain (Second Grain)

22 Core Portion (Second Granule)

24 Coating Portion (Second Coating Portion)

90 Excrement Treatment Material

92 Grain

94 Toilet

96 Urine

1. An excrement treatment material composed of a plurality of grains that are piled in a box-shaped toilet and have a water absorbing property,
wherein the plurality of grains include a first grain that absorbs urine excreted in the toilet, and a second grain that absorbs the urine, and
a water absorption rate of the second grain is smaller than a water absorption rate of the first grain.

2. The excrement treatment material according to claim 1,
wherein when the water absorption rate of the first grain is A % and the water absorption rate of the second grain is B %, (A−B)≥10 is satisfied.

3. The excrement treatment material according to claim 2,
wherein (A−B)≥20 is satisfied.

4. The excrement treatment material according to claim 1,
wherein a plurality of the first grains and a plurality of the second grains are provided.

5. The excrement treatment material according to claim 4,
wherein the number of the second grains is between 30% and 70% inclusive of a total number of the first and second grains.

6. The excrement treatment material according to claim 5,
wherein the number of the second grains is between 40% and 60% inclusive of the total number of the first and second grains

7. The excrement treatment material according to claim 1,
wherein a particle diameter of the second grain is larger than a particle diameter of the first grain.

8. The excrement treatment material according to claim 1,
wherein the first grain has a first granule,
the second grain has a second granule, and
the second granule is made of a material that has the same composition as the first granule.

9. The excrement treatment material according to claim 1,
wherein the first grain has a first granule,
the second grain has a second granule, and
the second granule is made of a material that has different composition from the first granule.

10. The excrement treatment material according to claim 8,
wherein the first grain has a first coating portion that contains an adhesive material and covers the first granule.

11. The excrement treatment material according to claim 10,
wherein the second grain has a second coating portion that contains an adhesive material and covers the second granule.

12. The excrement treatment material according to claim 11,
wherein the second coating portion is made of a material that has the same composition as the first coating portion.

13. The excrement treatment material according to claim 10,
wherein the second granule is uncovered in the second grain.

14. A method for manufacturing an excrement treatment material composed of a plurality of grains that are piled in a box-shaped toilet and have a water absorbing property, the method comprising:
a first grain forming step of forming a first grain that absorbs urine excreted in the toilet; and
a second grain forming step of forming a second grain that absorbs the urine,
wherein in the second grain forming step, the second grain is formed such that a water absorption rate of the second grain is smaller than a water absorption rate of the first grain.

15. The method for manufacturing an excrement treatment material according to claim 14,
wherein a plurality of the first grains are formed in the first grain forming step, and
a plurality of the second grains are formed in the second grain forming step.

16. The method for manufacturing an excrement treatment material according to claim 14,
wherein in the second grain forming step, the second grain is formed such that a particle diameter of the second grain is larger than a particle diameter of the first grain.

17. The method for manufacturing an excrement treatment material according to claim 14,
wherein the first grain forming step includes a first granulating step of forming a first granule that constitutes the first grain,
the second grain forming step includes a second granulating step of forming a second granule that constitutes the second grain, and
in the second granulating step, the second granule is formed that is made of a material having the same composition as the first granule.

18. The method for manufacturing an excrement treatment material according to claim 14,
wherein the first grain forming step includes a first granulating step of forming a first granule that constitutes the first grain,
the second grain forming step includes a second granulating step of forming a second granule that constitutes the second grain, and
in the second granulating step, the second granule is formed that is made of a material having different composition from the first granule.

19. The method for manufacturing an excrement treatment material according to claim 17,
wherein the first grain forming step includes a first coating step of forming a first coating portion that contains an adhesive material and covers the first granule.

20. The method for manufacturing an excrement treatment material according to claim 19,
wherein in the second grain forming step, the second grain is formed in which the second granule is uncovered.
